(19) United States
(12) Patent Application Publication
(10) Pub. No.: US 2006/0088643 A1
(43) Pub. Date: Apr. 27, 2006

(54) Neutraceutical composition containing mangosteen pericarp extract

(75) Inventors: Kenneth B. Fugal, Orem, UT (US); Trent L. McCausland, Springville, UT (US); Xiaolan Kou, Provo, UT (US); William J. Keller, Draper, UT (US)

Correspondence Address: FULBRIGHT AND JAWORSKI LLP, 555 S. FLOWER STREET, 41ST FLOOR, LOS ANGELES, CA, 90071, US

(73) Assignee: Nature's Sunshine Products, Inc.

(21) Appl. No.: 10/975,243

(22) Filed: Oct. 27, 2004

(51) Int. Cl. A23L 2/00

(52) U.S. Cl. 426/599

(57) ABSTRACT

A neutraceutical beverage comprising pericarp extract from the Garcinia mangostana L. (mangosteen) plant, and juice from mangosteen fruit pulp, preferably combined with juice from at least one of four other ingredients selected from red grapes, lycium, sea buckthorn, and apple, preferably obtained from powdered extract of mangosteen pericarp and a mixture of fruit concentrate and/or powdered fruit and/or fruit extract In a preferred embodiment the neutraceutical beverage comprises mangosteen pericarp extract and juice from each of mangosteen fruit pulp, red grapes, lycium, sea buckthorn, and apple. The mangosteen pericarp extract can be obtained by a process in which mangosteen pericarp is extracted with ethanol, for example, a 50% ethanol, 50% water solution, and the extract is dried under vacuum. The beverage optionally can include one or more additional fruit juices or concentrates, or fruit or plant extracts, such as concord grape concentrate, blueberry concentrate, red raspberry concentrate, powdered green tea extract, powdered grape seed extract, and powdered grape skin extract.

### FIELD OF THE INVENTION

The present invention relates to neutraceutical beverages comprising pericarp extract from the Garcinia mangostana L. (mangosteen), and juice from mangosteen fruit pulp, red grapes, lycium, sea buckthorn, and apple. More particularly, the present invention relates to such beverages obtained from powdered extract of mangosteen pericarp and a mixture of fruit concentrate and powdered fruit and fruit extract, including powdered mangosteen fruit pulp, red grape concentrate, powdered lycium extract, powdered sea buckthorn extract, and powdered apple extract.

### BACKGROUND OF THE INVENTION

According to Fruits of Warm Climates by Julia Morton (1), the mangosteen tree is believed to be originally from the Sunda Islands and the Moluccas of Indonesia in Southeast Asia. It is found cultivated in Thailand, Singapore, Malaya, southern Vietnam and Burma. Mangosteen trees are also common in the Phillipines and India.

The mangosteen fruit was said to be Queen Victoria's favorite fruit and is regarded as the “queen of fruits.” The fruit is round, 1⅓ to 3 inches in diameter. The ripe fruit is a dark-purple to red-purple color comprised of an outer rind and inner white flesh. The rind or pericarp is the tough outer section ¼ to ⅜ inch thick. This rind contains a bitter yellow latex and a purple, staining juice. Generally the fruit contains 1 to 5 oblong and flattened seeds.

The fruit is described as slightly acidic and delicious. Mangosteens are usually eaten as a dessert. The flesh can be canned but does lose some of the flavor due to the heating process. Jams and preserves are also made from the fruit segments. The rind can also be made into a purple jelly. The leaves, twigs, bark, rind, and fruit are also used for various purposes other than a food source. The twigs are used as chewsticks in Ghana. Due to the high amounts of tannins and rosin in the rind, the rind has been used for tanning leather. The rind also provides a black dye. The wood is heavy and durable. It has been used in handles for spears, rice pounders, and in cabinetwork. Many traditional medicinal uses for the fruit, rind, leaves, and bark have been recorded. The rind powder is administered for dysentery. A rind ointment is applied on eczema and skin disorders. The rind decoction is employed for relieving diarrhea, cystitis, and gonorrhea. The leaves and bark have been used in the Phillipines to treat thrush, diarrhea, dysentery and urinary disorders. For example, there are a number of folk medicines in South-east Asia and Indonesia that employ various decoctions of the leaves, root, and bark of the mangosteen plant, as well as of the pericarp of the mangosteen fruit. Other medicinal uses of the leaves, root and bark would be known to one of skill in the art.

In contrast to the thick outer pericarp, the edible inner pulp of the mangosteen fruit is widely regarded for its superb taste. The inner pulp of a single mangosteen fruit usually consists of four to eight juicy, white-colored segments. When preparing the white pulp segments for consumption, care must be taken so as to not stain the pulp segments with the resins and tannins and other matter that oozes out of the cut outer pericarp. The need to keep the tasty white pulp separate from the dark purple, staining, bitter pericarp has long been known to those familiar with the mangosteen fruit. Nevertheless, mangosteen fruit pulp and pericarp compositions have recently been made commercially available that are obtained by grinding the entire mangosteen fruit, including the fruit pulp and pericarp , to which juice concentrates are added, as described in U.S. Pat. No. 6,730,333 to Garrity et al.

Several constituents of Garcinina mangostana have been isolated and studied. Many of the active compounds are in a class of phytochemicals called xanthones. Alpha-mangostin, beta-mangostin, and gamma-mangostin currently are the most studied xanthones from mangosteen. There are many other xanthones, including derivatives of mangostin. While preliminary pharmacological studies have identified a number of possible health benefits, until the present invention, however, the benefits of the xanthone components of the pericarp have not been fully realized.

### SUMMARY OF THE INVENTION

The present invention fully exploits the benefits of the xanthone and other content of mangosteen pericarp, and enables significant other healthful benefits, by providing a neutraceutical beverage for use as a dietary supplement comprising mangosteen pericarp extract and juice from mangosteen fruit pulp, preferably combined with juice from at least one of four other ingredients selected from red grapes, lycium, sea buckthorn, and apple. The beverage is preferably formed from powdered extract of mangosteen pericarp and a mixture of fruit concentrate and/or powdered fruit and/or fruit extract In a preferred embodiment the neutraceutical beverage comprises mangosteen pericarp extract and juice from each of mangosteen fruit pulp, red grapes, lycium, sea buckthorn, and apple, preferably obtained from powdered extract of mangosteen pericarp and a mixture of fruit concentrate and powdered fruit and fruit extract, including powdered mangosteen fruit pulp, red grape concentrate, powdered lycium extract, powdered sea buckthorn extract, and powdered apple extract.

Thus, in a preferred embodiment, the present invention uses rich tasting mangosteen powder obtained from the whole fruit and seeds, without the pericarp, and combines it with powdered mangosteen pericarp extract and selected powdered fruit extract and concentrate to provide a neutraceutical composition having high antioxidant value and enhanced xanthone content. While maintaining the superb taste of mangosteen fruit and other fruit extracts, the pericarp extract greatly concentrates the amount of xanthones, increasing it by four to five-fold, and increasing the total polyphenols by one-fourth, compared to levels obtained from the composition without the pericarp extract.

In a preferred embodiment, the mangosteen pericarp extract is obtained by a process in which mangosteen pericarp is extracted with ethanol, for example, a 50% ethanol, 50% water solution, and the extract is dried under vacuum.

The beverage can optionally include one or more additional fruit juices or concentrates, or fruit or plant extracts, such as concord grape concentrate, blueberry concentrate, red raspberry concentrate, powdered green tea extract, powdered grape seed extract, and powdered grape skin extract.

### BRIEF DESCRIPTION OF THE DRAWINGS

FIG. 1 is a bar graph comparing the oxygen radical absorbance capacity of a formulation prepared in accordance with this invention compared to commercially available competing fruit drink formulations; and

FIG. 2 is a bar graph comparing the immuno-stimulatory response of a formulation prepared in accordance with this invention compared to a commercially available mangosteen formulation.

### DETAILED DESCRIPTION OF THE INVENTION

The inventors have discovered that a mixture of mangosteen pericarp extract and juice from mangosteen fruit pulp, preferably combined with specific other core ingredients provides surprising immune system stimulating response, as demonstrated by the examples described below. The specific other core ingredients are red grapes, lycium, sea buckthorn, and apple. The beverage is formed by combining powdered extract of mangosteen pericarp with powdered mangosteen fruit pulp obtained from the whole fruit and seeds, without the pericarp, and preferably with a mixture of fruit concentrate and powdered fruit and fruit extract, including, red grape concentrate, powdered lycium extract, powdered sea buckthorn extract, and powdered apple extract. Each of the core ingredients contains many active compounds relating to specific health benefits. Many of these compounds have been studied extensively in the scientific field. By combining these key ingredients, preferably in concentrated form, the benefits to health and well-being are maximized. Importantly, the formulation has a pleasing taste.

The beverage can optionally include one or more additional fruit juices or concentrates, or fruit or plant extracts, such as concord grape concentrate, blueberry concentrate, red raspberry concentrate, powdered green tea extract, powdered grape seed extract, and powdered grape skin extract. While these are more commonly known ingredients, the importance of these ingredients should not be diminished. Each of these additional ingredients is well-known for its antioxidant and health promoting benefits.

Preferred amounts of the ingredients are given in Table 1:

TABLE 1

| | Weight % Range |
|---|---|
| Core Ingredient | |
| Mangosteen fruit pulp powder | 2.0-5.0 |
| Mangosteen pericarp extract powder | 0.10-0.85 |
| Red grape concentrate | 5.0-7.5 |
| Lycium extract powder | 0.1-0.25 |
| Sea buckthorn extract powder | 0.1-0.25 |
| Apple fruit extract powder | 0.02-0.1 |
| Optional Ingredients | |
| Concord grape concentrate | 5-7.5 |
| Blueberry concentrate | 2.5-5.0 |
| Red raspberry concentrate | 1-2.5 |
| Green tea extract powder | 0.02-0.1 |
| Grape seed extract powder | 0.02-0.1 |
| Grape skin extract powder | 0.5-1.0 |
| Water Balance to 100 | |

The neutraceutical beverage can be prepared by mixing the powdered extracts and fruit concentrates in any order, although it is preferred to pre-form a quad blend of the fruit concentrates, and adding that with the other ingredients. Thus, 20 weight percent of the mixture can be formed of a blend having the composition in Table 2:

TABLE 2

| Quad-Blend Ingredient | Weight % Range in Blend |
|---|---|
| Red grape concentrate | 25.4-38.1 |
| Concord grape concentrate | 25.4-38.1 |
| Blueberry concentrate | 12.7-25.4 |
| Red raspberry concentrate | 5.1-12.7 |

The following will describe the foregoing ingredients in more detail.

Mangosteen Fruit PuIp and Mangosteen Pericarp Extract

Mangosteen (Garcinia mangostana) consists of a white, fleshy fruit surrounded by an outer purple rind also called pericarp. The fruit and especially the pericarp are rich in xanthones. Xanthones are a class of active phytochemicals. Several xanthones have specifically been isolated from mangosteen with mangostin being one of the most studied. However, many xanthones (40+) have been isolated and elucidated from mangosteen. As described in the background of this invention, mangosteen fruit, rind, leaves, and roots have a history of use in Singapore, India, China, and several other oriental countries. The historical uses include using the rind to overcome dysentery, diarrhea, cystitis, and gonorrhea. Topical use for wounds and infections has also been noted (1-2).

Studies have shown that mangosteen and the xanthones in the fruit have antibacterial and antifungal action (3-4). The Handbook of Biologically Active Phytochemicals and Their Actives (5), lists mangostin as a compound with antiseptic, bactericide, and fungicide properties. Pericarp extracts stimulated immune phagocytic cell function, which killed Salmonella enteritidis bacteria (6). The immune response is attributed to active polysaccharide compounds. Other studies have shown an inhibitory effect against Staphylococcus aureus and Mycobacterium tuberculosis (7-8). Preliminary research on cancer cell line screenings is also promising. The xanthone garcinone E inhibited the growth of hepatocellular carcinomas as well as gastric and lung cancer cell lines (9). Alpha mangostin xanthone had a growth inhibitory effect on human leukemia cell line HL60 and a pericarp extract inhibited breast cancer cells (10-11). Xanthones are also antioxidants. Mangostins are free-radical scavengers and inhibit the oxidation of low density lipoprotein (LDL) cholesterol (12-13). This is a protective factor for the cardiovascular system. Another xanthone, gamma-mangostin, has inhibitory activity against prostaglandin E2. It also is a COX 1 and 2 inhibitor, which may relieve pain (14-15). Inhibition of these compounds reduces inflammation, such as that in arthritis.

By using the rich tasting fruit as well as the pericarp extract, mangosteen becomes a key ingredient for antioxidant value and active compounds, especially for the xanthone content. The combination of pericarp extract greatly concentrates the amount of xanthones. By adding the pericarp extract to the Formulation product, the level of xanthones increased four to five- fold. In addition, the total polyphenols increased by one-fourth. As used in the invention, the mangosteen powder is obtained commercially, freeze-dried from the whole fruit and seeds, without the pericarp. The pericarp extract powder is obtained from a 50% ethanol/50% water extraction and is then dried under vacuum. It is standardized to a target of 195 milligrams/gram xanthones, and not less than 27% total polyphenols.

Lycium Fruit Extract

Lycium (Lycium barbarum) is also called wolfberry. The Chinese have used wolfberry fruit and bark for hundreds of years. They used this herb to strengthen muscles and bone, protect liver function, replenish the vital essence, treat diabetes, prevent aging and improve visual acuity. Disease prevention and prolongation of life may be due to lycium's immune enhancing effects as well as protecting against DNA and cellular damage (16).

The fruit contains the carotenoid, zeaxanthin (17), along with several vitamins, such as carotene (vitamin A analog), niacin, and vitamin C. It also contains polysaccharides, flavonoids, and phenols. Lycium fruits are reported to cause an increase in leukocyte counts, immune cell activity, and nonspecific immunity, and stimulation of tissue development (16). The polysaccharides, glycoconjugates, flavonoids, and phenolic amides appear to have potent antioxidant properties, in some cases, similar to that of superoxide dismutase (SOD) (18). Some of these antioxidants inhibit LDL peroxidation (19), while others provide a hepatoprotective effect. Research has shown that lycium berry helped improve immune function, dark adaptation, and vision (18). An herbal extract helped to lower blood pressure and stimulate the heart (16).

As used in the invention, the lycium fruit extract powder is extracted in water, standardized to contain not less than 10% polysaccharides, then vacuum dried.

Sea Buckthorn Fruit Extract

Sea Buckthorn (Hippophae rhamnoides) is native to China. It also grows in many European and Asian countries. The Chinese use sea buckthorn for stomach aches. Elsewhere the plant is used for diarrhea, eruptions, lung ailments, scurvy, skin ailments, stomach ache, and tumors (20). The nutrient rich berries have been used as a supplement source for vitamins C, A, and E as well as flavonoids, superoxide dismutase, minerals, and amino acids. Other components include the carotenoids beta carotene, cryptoxanthin, lycopene and zeaxanthin (17,21).

Sea buckthorn has potent antioxidant activity, mainly attributed to the vitamin C content as well as the flavonoids (22). An in vitro study showed that sea buckthorn protected cells from lipid peroxidation through its antioxidant effect. Guarding against lipid peroxidation is one factor that is correlated with anti-atherosclerotic activity (23). Sea buckthorn flavonoids were given to patients with ischemic heart disease, who then had a decrease in cholesterol level as well as improved cardiac function and less angina (24). This may explain the use of sea buckthorn to lower blood pressure and cholesterol levels, as well as preventing blood vessel disease. Sea buckthorn helps the body use oxygen efficiently and increases overall energy. The berries are also used to boost immunity, prevent infections, and improve vision (25). The carotenoid content and antioxidant activity may be useful in aiding vision in situations such as macular degeneration and night vision. A recent study shows that it may be possible to reduce the risk of age related macular degeneration by adding extra amounts of zeaxanthin to the diet (26). Other preliminary information points to the usefulness of sea buckthorn seed oil in gastric ulcers, liver protection, and skin nourishment (25).

As used in the invention, the Sea buckthorn fruit extract powder is extracted in water and standardized to not less than 8% total flavonoids. It is then spray dried.

Apple Fruit Extract

Apple fruit extract (Malus domestica) comes from the skin and fruit of immature apples. The processing concentrates the amount of polyphenolics, including procyanidins. Procyanidins are a subclass of flavonoids which have attracted attention due to their potential health benefits as powerful antioxidants which offer protection for the cardiovascular system, as well as other body systems.

The major antioxidant components in apples are more highly concentrated in the skin of the apple than the fruit. These compounds include quercetin glycoside, procyanidin B, phloretin glycoside, chlorogenic acid, and epicatechin. One average apple may contain several hundred milligrams of polyphenolics which is considerably more than one serving of red wine (27-28).

As used in the invention, the apple fruit extract powder is obtained as Applephenon SH powder, a concentrate from the whole fruit, standardized to not less than 80% total polyphenols and spray dried.

Red Grape Concentrate

The typical French diet is often high in fat, but the French have a lower incidence of heart disease. This occurrence is often referred to as the French paradox. The lower rate of heart disease is in part attributed to the frequent consumption of red wines. However, red grapes do not have to be ingested in wine form for one to reap the health benefits.

Red grapes (Vitis vinifera) contain antioxidant pigments called anthocyanins. Red grapes also contain other phenols and flavonoids. One important polyphenolic compound is resveratrol. Resveratrol is used to help protect against cardiovascular disease and atherosclerosis (narrowing of the arteries). Resveratrol inhibits platelet aggregation, caused blood vessel dilation and is used to lower cholesterol levels. The phenolic compounds in red grapes have antioxidant properties and inhibit LDL oxidation. Red grapes are used because they tend to produce more oxidation protection than white or blush grape varieties (25).

As used in the invention, the red grape, and the concord grape, blueberry, and red raspberry liquid concentrates described below, are obtained commercially in liquid form , each derived from their whole fruit from which the juice is extracted and filtered.

Concord Grape Concentrate

Purple grapes (Vitis labrusca) contain similar antioxidant pigments that found in red grapes. Purple grape juice has been shown to protect against many factors involved in cardiovascular disease including inhibiting platelet function and reducing LDL oxidation. The research is important because these effects are independent of alcohol. Purple and red grapes do not have to be ingested in wine form for one to reap these health benefits (29-34).

Blueberry Concentrate

Blueberries (Vaccinium corymbosum) contain anthocyanins pigments which give blueberries their dark color. These anthocyanins are also responsible for the health benefits associated with blueberries. The USDA Human Nutrition Center ranked blueberries as the number one antioxidant over 40 fruits and vegetables tested. Animal research showed that blueberries may have anti- aging potential for the brain. Other information suggests that blueberries may also help vision and cholesterol levels. Blueberry juice has bacteria-fighting properties that work against urinary tract infections. The juice compounds prevent the bacteria from adhering to the urinary tract wall (25,35, 36).

Red Raspberry Concentrate

Raspberries (Rubus idaeus) contain very high levels of ellagic acid. Ellagic acid has been proven to be an effective antimutagen, anticarcinogen and inhibitor of cancer. Like some of the other fruits mentioned, raspberries are also high in anthocyanins. Research has linked anthocyanin activity to improved vision and circulation, preventing cancer, and slowing the effects of aging especially related to memory and motor-skills (37).

Red Grape Skin Extract and Grape Seed Extract

Red grapeskin (Vitis vinifera) also contains resveratrol as well as anthocyanin compounds. Grape seed is well known for its oligomeric proanthocyanidins (OPCs). Proanthocyanidins are many times more powerful as antioxidants than vitamin C and vitamin E. Grape seed is used for treating and preventing cardiovascular disorders such as atherosclerosis or venous insufficiency. It is also used to strengthen the blood vessels, improve wound healing, macular degeneration, poor night vision, and inflammation (25). As used in the invention, the grape seed extract powder is standardized to not less than 83% total polyphenols and vacuum dried.

Green Tea Leaf Extract

Green tea (Camellia sinensis) offers antioxidant protection against diseases as well as protecting the cells against chromosome damage by reducing oxidative DNA damage, lipid peroxidation, and free radical generation. Green tea may help lower cholesterol levels and protect against heart disease. Several studies have looked at green tea for cancer prevention. The key compounds include several catechins, epigallocatechin-3-gallate being the most notable (25). As used in the invention, the green tea leaves extract powder is decaffeinated, standardized to not less than 80% polyphenols, and spray dried.

The following example will further illustrate the invention.

### EXAMPLE 1

The quad-blend ingredients in Table 3 were blended together in the amounts indicated and the blend was mixed with the other ingredients in Table 3, in the amounts indicated, to prepare a formulation of this invention, which will be referred to as the Thai-Go formulation.

TABLE 3

| Ingredient | Quad wt. % | Gram wt. | Wt. % |
|---|---|---|---|
| Quad-blend: | | 155.17 | |
| Red grape concentrate* | 36.0 | 55.86 | 7.09 |
| Concord grape concentrate | 36.0 | 55.86 | 7.09 |
| Blueberry concentrate | 21.5 | 33.36 | 4.23 |
| Red raspberry concentrate | 6.53 | 10.09 | 1.28 |
| Mangosteen fruit pulp powder* | | 18.50 | 2.35 |
| Mangosteen pericarp extract* | | 1.50 | 0.19 |
| Green tea extract 80% powder | | 0.15 | 0.02 |
| Lycium extract powder* | | 0.75 | 0.10 |
| Sea buckthorn extract powder* | | 0.75 | 0.10 |
| Grape seed extract powder | | 0.15 | 0.02 |
| Applephenon SH powder* | | 0.15 | 0.02 |
| Grape skin extract powder | | 5.00 | 0.63 |
| Water | | 606.00 | 76.89 |
| Total | | 788.12 | 100.0 |

*The six core ingredients comprise 9.85% of the formulation. The other six fruit and herb ingredients comprise 13.26% of the formula. Water makes up the remaining 76.89% of the formula.

In preparing the Thai-Go formulation, water is added at 120° F. to a mixing tank. Then, while mixing, the mangosteen powder is added, followed by the other dry powders. The quad-blend concentrate is then added and the mixture is stirred for at least 10 minutes. The pH is then tested for a range is 2.9 to 3.4. The Brix is then tested for a range of 14.5 to 16.5. The product is milled at 0.004 inch through a colloidal mill, then pasteurized at 195° F. for 45 seconds. Bottles are filled at 175° F.

### EXAMPLE 2

Characterization tests were run on the product of Example 1, Thai-Go, including the oxygen radical absorbance capacity (ORAC), total polyphenolics, xanthones, and immune response, described below ORAC

ORAC was measured as a way of determining antioxidant strength. In this test a control called Trolox, a water soluble derivative of vitamin E (vitamin E itself is fat soluble, not water soluble), is used as the control standard of antioxidant activity. Ingredients are then tested for antioxidant activity (ORAC) compared to Trolox. One ORAC unit is defined as micromoles of Trolox Equivalence (TE) per gram or liter of the sample.

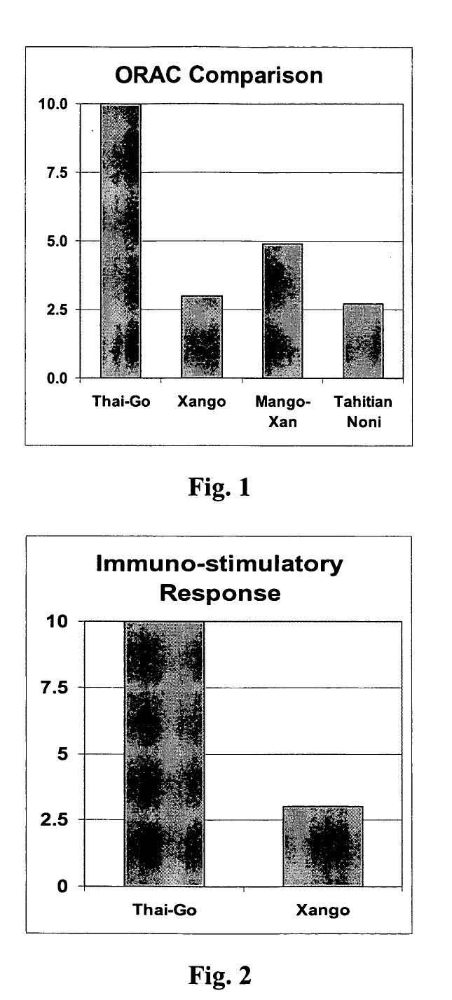

Brunswick Laboratories of Wareham, MA conducted the ORAC assay on the Thai-Go. They also compared the Thai-Go to some competitor's products mainly XanGO™, MangoXan™, and Tahitian Noni™. Referring to FIG. 1, the results showed that Thai-Go had more than twice the antioxidant capacity than XanGo, MangoXan, and Tahitian Noni.

Total Polyphenolics

Plant Polyphenolics are a large class of water soluble compounds. The most common in foods are flavonoids, which contribute to the color and flavor of many foods (38). Flavonoids can further be categorized in the classes flavonols, flavones, flavanols, procyanidins and anthocyanin pigments (39). Polyphenolics are reported to help prevent diseases such as atherosclerosis, cardiovascular disease, arthritis, nerve degeneration, and osteroporosis (40). Several of the ingredients contain the polyphenols resveratrol and catechins. Methods have been developed to measure total amounts of these specific compounds, which for the Thai-Go product is 0.44% total polyphenols.

Xanthones

In addition, xanthone content is measured through analytical means. The pericarp extract individually as a raw material has been standardized to a specific xanthone and polyphenolic specification, for xanthones a target of 195 mg/gram, for total polyphenols, not less than 27%.

Immune Response

Dr. David Pasco of the National Center for Natural Products Research, University of Mississippi used a monocyte/macrophage activation assay to compare the Thai-Go to Xang™ in an immune response test. Referring to FIG. 2, the results showed that Thai-Go outperformed Xango™ better than three times in stimulating a cellular immune system response.

### REFERENCES

Mangosteen

1. Morton, J. 1987. Mangosteen. p. 301-304. In: Fruits of warm climates. Julia F. Morton, Miami, Fla. (update 1999)
2. CRC Ethnobotany Desk Reference, Timothy Johnson, 1999 CRC Press, pg 364
3. Sundaram B M, et al., Antimicrobial activities of Garcinia mangostana. Planta Med. May 1983; 48(1):59-60.
4. Gopalakrishnan G, et al. Evaluation of the antifungal activity of natural xanthones form Garcinina mangostana and their synthetic derivatives. J Nat Prod. May 1997; 60(5):519-24.
5. The Handbook of Biologically Active Phytochemicals and Their Actives, James Duke, CRC press, 1992, pg 104.
6. Chanarat P, et al. Immunopharmacological activity of polysaccharide from the pericarp of mangosteen garcinia: phagocytic intracellular killing activities. J Med Assoc Thai. September 1997; 80 Suppl 1:S149-54.
7. Iinuma M, et al. Antibacterial activity of xanthones from guttiferaeous plants against methicillin-resistant Staphylococcus aureus. J Pharm Pharmacol. August 1996; 48(8):861-5.
8. Suksamrarn S, et al. Antimycobacterial activity of prenylated xanthones from the fruits of Garcinia mangostana. Chem Pharm Bull (Tokyo). July 2003; 51 (7):857-9.
9. Ho, C K, et al. Garcinone E, a xanthone derivative, has potent cytotoxic effect against hepatocellular carcinoma cell lines. Planta Med. November 2002 ; 68(11):975-9.
10. Moongkarndi P et al. Antiproliferation, antioxidation and induction of apoptosis by Garcinia mangostana (mangosteen) on SKBR3 human breast cancer cell line. J Ethnopharmacol. January 2004; 90(1):161-6.
11. Matsumoto K, et al. Induction of apoptosis by xanthones from mangosteen in human leukemia cell lines. J Nat Prod. August 2003 ; 66(8):1124-7.
12. Williams P, et al. Mangostin inhibits the oxidative modification of human low density lipoprotein. Free Radic Res. August 1995; 23(2):175-84.
13. Mahabusarakam W, et al. Inhibition of lipoprotein oxidation by prenylated xanthones derived from mangostin. Free Radic Res. November 2000; 33(5):643-59.
14. Gopalakrishnan C, et al. Effect of mangostin, a xanthone from Garcinia mangostana Linn. in immunopathological & inflammatory reactions. Indian J Exp Biol. August 1980; 18(8):843-6.
15. Nakatani K, et al. Inhibition of cyclooxygenase and prostaglandin E2 synthesis by gamma-mangostin, a xanthone derivative in mangosteen, in C6 rat glioma cells. Biochem Pharmacol. Jan. 1, 2002; 63(1):73-9.
   Lycium
16. The Pharmacology of Chinese Herbs, Second Ed., Huang K C. CRC Press. Boca Raton, RL. 1999.
17. Weller P, Breithaupt D E. Identification of zeaxanthin esters in plants using liquid chromatography-mass spectrometry. J Agric Food Chem Nov. 19, 2003; 51(24):7044-9
18. Encyclopedia of Common Natural Ingredients: Used in Foods, Drugs, and Cosmetics. 2^{nd} Ed. Leung A Y and Foster S. John Wiley and Sons, Inc. New York. 1996.
19. Huang L J, et al. Studies on the glycoconjugates and glycans from Lycium barbarum L in inhibiting low density lipoprotein (LDL) peroxidation. Yao Xue Xue Bao. February 2001; 36(2):108-11.
   Sea Buckthorn
20. Medicinal Plants of China. Duke J A and Ayensu E S. Volume One. Reference Publications Inc. 1985)
21. Zeb A. Chemical and Nutritional Constituents of Sea Buckthorn Juice. Pakistan Journal of Nutrition 3(2): 99-106, 2004.
22. Rosch D, et al. Structure-antioxidant efficiency relationships of phenolic compounds and their contribution to the antioxidant activity of sea buckthorn juice. J Agricultural Food Chemistry 2003; 51(15):4233-4239
23. Wang Y, et al. The protective effect of Hippophae rhamnoides L. on hyperlipidemic serum cultured smooth muscle cells in vitro. Zhongguo Zhong Yao Za Zhi. October 1992; 17(10):624-6, 601 inside.
24. Xiao Z, et al. The inhibitory effect of total flavonoids of hippophae on the activation of NF-kappa beta by stretching cultured cardiac myocytes. Sichuan University Medical Journal 2003; 34(2):283-285.
25. Natural Medicines Comprehensive Database. 4^{th} Ed. Jellin J M, Gregory P J, Batz F, Hitchens K, et al. Stockton, Calif.: Therapeutic Research Faculty; 2002.
26. Cited in: Health Products Business. Cygnus Business Media. Ft Atkinson, Wis. August 2004, page 9.
   Apple Fruit Extract
27. Tsao R, et al. Polyphenolic profiles in eight apple cultivars using high-performance liquid chromatography (HPLC). J Agric Food Chem. Oct. 8, 2003; 51(21):6347-53.
28. Hammerstone J F, et al. Procyanidin content and variation in some commonly consumed foods. J Nutr. August 2000; 130(8S Suppl):2086S-92S.
   Concord Grape
29. Folts J D. Potential health benefits from the flavonoids in grape products on vascular disease. Adv Exp Med Biol. 2002;505:95-111
30. Chou E J et al. Effect of ingestion of purple grape juice on endothelial function in patients with coronary heart disease. Am J Cardiol. Sep. 1, 2001; 88(5):553-5
31. Freedman J E, et al. Select flavonoids and whole juice from purple grapes inhibit platelet function and enhance nitric oxide release. Circulation. Jun. 12, 2001; 103(23):2792-8
32. Keevil J G, et al. Grape juice, but not orange juice or grapefruit juice, inhibits human platelet aggregation. J Nutr. January 2000; 130(1):53-6
33. Stein J H, et al. Purple grape juice improves endothelial function and reduces the susceptibility of LDL cholesterol to oxidation in patients with coronary artery disease. Circulation. Sep. 7, 1999; 100(10):1050-5
34. Concord Grape Association www.concordgrape.org: Experimental Biology Society 2003—Study, Drinking Concord Grape Juice May Reduce Blood Pressure in Hypertensive Men
   Blueberry
35. Heinerman's Encyclopedia of Healing Juices. John Heinerman. Pg 47
36. US Blueberry Council www.blueberry.org
   Raspberry
37. Oregon Raspberry and Blackberry Commission Nutraceutical Information www.oregon-berries.com
   Other
38. Phytochemicals Mechanisms of Action, Meskin, Miss., et al., 2004, p 80-81.
39. Wrolstad, R E. Assessing berries' health potential. Cited in: Functional Foods & Nutraceuticals May 2004, pp 26-27.
40. Middleton E, et al. The effects of plant flavonoids on mammalian cells: implications for inflammation, heart disease, and cancer. Pharmacol. Rev. 52, 673, 2000.

1. A neutraceutical beverage comprising:
pericarp extract from the fruit of a Garcinia mangostana L. (mangosteen) tree; and
juice from mangosteen fruit pulp.

2. The beverage of claim 1 combined with juice from at least one of four other ingredients selected from red grapes, lycium, sea buckthorn, and apple.

3. The beverage of claim 1 combined with juice from each of red grapes, lycium, sea buckthorn, and apple.

4. The beverage of claim 3 combined with one or more additional fruit juices, concentrates, or fruit or plant extracts.

5. The beverage of claim 4 in which said one or more additional fruit juices, concentrates, or fruit or plant extracts comprises one or more of concord grape juice, blueberry juice, red raspberry juice, green tea extract, grape seed extract, and grape seed extract.

6. The beverage of claim 3 combined with each of concord grape juice, blueberry juice, red raspberry juice, green tea extract, grape seed extract, and grape seed extract.

7. The beverage of claim 1 obtained from powdered extract of mangosteen pericarp and powdered mangosteen fruit pulp powder.

8. The beverage of claim 7 combined with at least one of four other ingredients selected from red grape concentrate, powdered lycium extract, powdered sea buckthorn extract, and powdered apple extract.

9. The beverage of claim 7 combined with each of red grape concentrate, powdered lycium extract, powdered sea buckthorn extract, and powdered apple extract.

10. The beverage of claim 9 combined with one or more of concord grape concentrate, blueberry concentrate, red raspberry concentrate, powdered green tea extract, powdered grape seed extract, and powdered grape seed extract.

11. The beverage of claim 9 combined with each of concord grape concentrate, blueberry concentrate, red raspberry concentrate, powdered green tea extract, powdered grape seed extract, and powdered grape seed extract.

12. The beverage of claim 9 having the formula:

| | Weight % Range |
|---|---|
| Core Ingredient | |
| Mangosteen fruit pulp powder | 2.0-5.0 |
| Mangosteen pericarp extract powder | 0.10-0.85 |
| Red grape concentrate | 5.0-7.5 |
| Lycium extract powder | 0.1-0.25 |
| Sea buckthorn extract powder | 0.1-0.25 |
| Apple fruit extract powder | 0.02-0.1 |
| Optional Ingredients | |
| Concord grape concentrate | 5-7.5 |
| Blueberry concentrate | 2.5-5.0 |
| Red raspberry concentrate | 1-2.5 |
| Green tea extract powder | 0.02-0.1 |
| Grape seed extract powder | 0.02-0.1 |
| Grape skin extract powder | 0.5-1.0 |
| Water Balance to 100 | |

13. The beverage of claim 12 in which the concentrates are in the form of a quad-blend having the formula:

| Quad-Blend Ingredient | Weight % Range in Blend |
|---|---|
| Red grape concentrate | 25.4-38.1 |
| Concord grape concentrate | 25.4-38.1 |
| Blueberry concentrate | 12.7-25.4 |
| Red raspberry concentrate | 5.1-12.7 |

14. The beverage of claim 9 having the formula:

| Ingredient | Quad wt. % | Gram wt. | Wt. % |
|---|---|---|---|
| Quad-blend: | | 155.17 | |
| Red grape concentrate* | 36.0 | 55.86 | 7.09 |
| Concord grape concentrate | 36.0 | 55.86 | 7.09 |
| Blueberry concentrate | 21.5 | 33.36 | 4.23 |
| Red raspberry concentrate | 6.53 | 10.09 | 1.28 |
| Mangosteen fruit pulp powder* | | 18.50 | 2.35 |
| Mangosteen pericarp extract* | | 1.50 | 0.19 |
| Green tea extract 80% powder | | 0.15 | 0.02 |
| Lycium extract powder* | | 0.75 | 0.10 |
| Sea buckthorn extract powder* | | 0.75 | 0.10 |
| Grape seed extract powder | | 0.15 | 0.02 |
| Applephenpn SH powder* | | 0.15 | 0.02 |
| Grape skin extract powder | | 5.00 | 0.63 |
| Water | | 606.00 | 76.89 |
| Total | | 788.12 | 100.0 |

15. The beverage of claim 1 in which the mangosteen pericarp extract is obtained by extracting mangosteen pericarp with ethanol.

16. The beverage of claim 15 in which the mangosteen pericarp extract is dried under vacuum.

17. The beverage of claim 1 in which the mangosteen pericarp extract is obtained by extracting mangosteen pericarp with a 50% ethanol, 50% water solution, and the extract dried under vacuum.
